(19) United States
(12) Patent Application Publication
(10) Pub. No.: US 2025/0019550 A1
(43) Pub. Date: Jan. 16, 2025

(54) TWO-COMPONENT THERMALLY CONDUCTIVE POLYURETHANE GAP FILLER COMPOSITION

(71) Applicant: JNC MATERIALS CO., LTD, Jecheon-si, Chungcheongbuk- do (KR)

(72) Inventors: Hak Min LEE, Anseong-si, Gyeonggi-do (KR); Jun Hwa LEE, Gwangju-si, Gyeonggi-do (KR); Soo Ryeon LEE, Seoul (KR)

(73) Assignee: JNC MATERIALS CO., LTD, Jecheon-si, Chungcheongbuk- do (KR)

(21) Appl. No.: 18/711,105

(22) PCT Filed: Dec. 7, 2022
(86) PCT No.: PCT/KR2022/019849

§ 371 Date: May 16, 2024

(30) Foreign Application Priority Data
Dec. 14, 2021 (KR) 10-2021-0178537
Dec. 2, 2022 (KR) 10-2022-0167086

(51) Int. Cl. C09D 5/34; C09D 5/04; C09D 7/45; C09D 7/61; C09D 7/63; C09D 175/04

(52) U.S. Cl. CPC C09D 5/34; C09D 5/04; C09D 7/45; C09D 7/61; C09D 7/63; C09D 175/04

(57) ABSTRACT

The present invention relates to a two-component thermally conductive polyurethane gap filler composition and, more particularly, provides a two-component thermally conductive polyurethane gap filler composition comprising: a primary composition comprising a catalyst and two or more mixtures selected from a polyol having one hydroxyl group, a polyol having two hydroxyl groups, and a polyol having 3 to 64 hydroxyl groups; and a curing agent composition comprising a moisture scavenger, a curing retardant, and at least one selected from a monomer having 2 or less isocyanate groups at a terminal and a polyurethane precursor obtained by reacting a monomer having 2 or less isocyanate groups at a terminal and a polyol.

### FIELD OF THE INVENTION

The present invention relates to two-component thermally conductive polyurethane (PU) composition that is capable of being preserved at room temperature for 180 days or more and, most particularly, to a secondary cell (or rechargeable battery) module, pack, and battery management system (hereinafter referred to as “BMS”) for an electric/electronic device and transportation means driven by a secondary cell including a thermally conductive gap filler that is generated from the composition.

### BACKGROUND ART

As a recent solution for global environment conservation, part or all of the power driving transportation means has been replaced with secondary cells. However, heat that is generated during the charging and discharging of the secondary cell (or battery) may affect the performance and life (or storage life) of the battery and may also have a potential risk of explosion caused by a thermal runaway. Accordingly, a thermally conductive gap filler is being known as an important component in secondary cell modules, packs, as well as BMS.

Curable silicone compositions including thermally conductive ceramics have shown excellent thermal conductivity, thermal resistance, cold resistance, and electric insulation and have, therefore, been used as a thermal interface material (TIM) for a long time. Most particularly, the U.S. Pat. No. 9,203,064 B2 discloses a battery pack for electric cars (or vehicles) and mentions a silicone thermally conductive gap filler.

However, since a case of a secondary cell pack, module, and so on, for electric cars (or battery electric cars) generally uses a metallic substance for stability and thermal conductivity in the transportation means, there lies a problem in that the silicone group gap filler cannot provide sufficient adhesion (or adhesive force) to the metallic substance, which is a heterogeneous substance. Accordingly, the need for developing a thermally conductive gap filler capable of resolving such problems has been required.

In order to overcome such problems, various patent documents, such as the Korean Registered patent application Ser. No. 10/232,9736, are disclosing polyurethane group gap fillers for increasing adhesion (or adhesive force) between a gap filler and a metallic case, which is a heterogeneous substance. However, in a curing agent composition of a polyurethane group gap filler, a polyurethane prepolymer having a monomer having an isocyanate functional group (or isocyanate group) at a terminal react with a polyol reacts with free moisture, thereby generating an amine having a reaction speed (or rate) with an isocyanate group that is several tens of thousand times faster than a polyol having a hydroxyl functional group (or hydroxyl group) at a terminal, the polyol being the main agent. Thus, the preservation stability of the curing agent composition is degraded, according to which the problem of having to preserve the composition in a refrigerated condition of 10 degrees Celsius (10° C.) or less or in a freezing condition of −15° C. or less still remains.

### DETAILED DESCRIPTION OF THE INVENTION

### Technical Objects

The present invention has been devised to resolve the technical problems of the above-described prior art. Accordingly, an object of the present invention is to provide a two-component thermally conductive polyurethane (PU) composition that is capable of being preserved at room temperature for 180 days or more.

Another object of the present invention is to provide a secondary cell (or rechargeable battery) module, pack, and BMS for an electric/electronic device and transportation means driven by a secondary cell including a thermally conductive gap filler that is generated from the composition.

### Technical Solutions

In order to achieve the above-described object of the present invention, provided herein is a two-component thermally conductive polyurethane gap filler composition comprising a primary agent composition comprising a mixture of two or more polyol types selected from a polyol having one hydroxyl group, a polyol having two hydroxyl groups, and a polyol having 3 to 64 hydroxyl groups, and a catalyst; and a curing agent composition comprising at least one selected from a monomer having 2 isocyanate groups or less at a terminal, a polyurethane precursor generated by reacting a monomer having 2 isocyanate groups or less at a terminal with a polyol, a moisture scavenger, and a curing retardant.

It is preferable that the primary agent composition or curing agent composition further comprises at least one of a thermally conductive ceramic and a flame-retardant ceramic.

It is preferable that the primary agent composition or curing agent composition further comprises a dispersing agent and a thixotropy assigning additive.

It is preferable that the moisture scavenger contains at least one or more of oxazolidine derivatives each having a structure including Chemical formula 1 as shown below:

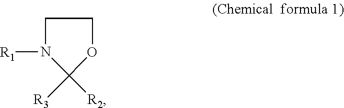

wherein
R₁ is a linear hydrocarbon with 1˜4 carbons or a branched hydrocarbon with 3˜8 carbons,
R₂ is a linear hydrocarbon with 1˜12 carbons or a branched hydrocarbon with 3˜18 carbons, and
R₃ is a methyl group (CH₃—) or hydrogen (H).

It is preferable that the curing retardant contains at least one or more of acyl halide derivatives each having a structure including Chemical formula 2 as shown below:

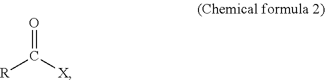

wherein R is:
1. an aliphatic hydrocarbon, or an aliphatic hydrocarbon being replaced with at least one type selected from an Alkyl (Cn=1˜18), an Isoalkyl (Cn=3˜18), an Alkenyl (Cn=2˜18), and an Isoalkenyl (Cn=4˜18),
2. an aromatic hydrocarbon, or an aromatic hydrocarbon being replaced with one to five types selected from an Alkyl (Cn=1˜8), an Isoalkyl (Cn=3˜8), an Alkenyl (Cn=2˜8), and an Isoalkenyl (Cn=4˜8),
3. a bicyclic aromatic hydrocarbon (BAH), or a bicyclic aromatic hydrocarbon being replaced with one to seven types selected from an Alkyl (Cn=1˜8), an Isoalkyl (Cn=3˜8), an Alkenyl (Cn=2˜8), and an Isoalkenyl (Cn=4˜8), and
4. a polycyclic aromatic hydrocarbon (PAH) having three to five rings, or a polycyclic aromatic hydrocarbon being replaced with one to four types selected from an Alkyl (Cn=1˜8), an Isoalkyl (Cn=3˜8), an Alkenyl (Cn=2˜8), and an Isoalkenyl (Cn=4˜8).

Additionally, X is a halogen atom.

Additionally, it is preferable that, when a weight of the composition is given as 100%, the composition comprises 0 to 50% by weight of the polyol having one hydroxyl group, 50 to 99.9% by weight of the polyol having two hydroxyl groups, and 0.1 to 10% by weight of the polyol having 3 to 64 hydroxyl groups.

It is preferable that, among the compositions, the monomer having 2 isocyanates or less at a terminal and the prepolymer both configuring the curing agent, are used within a range of 80% to 120% for each hydroxyl value of the primary agent. Herein, the aforementioned supremum and infimum are related to the degree of cure, and, therefore, when values are not within the range of the aforementioned supremum and infimum, this causes decrease in all degrees of cure. Therefore, the aforementioned range has a critical significance. That is, within the aforementioned range, the degree of cure becomes high, and the hardness also becomes high.

Most particularly, provided herein is a two-component thermally conductive polyurethane gap filler capable of being preserved at room temperature for 180 days or more. Herein, the two-component thermally conductive polyurethane gap filler may include a primary agent composition comprising a mixture of at least two or more of a polyol having one hydroxyl group, a polyol having two hydroxyl groups, and a polyol having 3 to 64 hydroxyl groups at a terminal; and at least one of a thermally conductive ceramic and a flame-retardant ceramic; a catalyst for curing, wherein, in some cases, the primary agent composition may include a dispersing agent enhancing dispersity, a thixotropy assigning additive assigning thixotropy, and so on; and a curing agent composition comprising at least one of a monomer having 2 isocyanate groups or less at a terminal and a polyurethane prepolymer reacting a monomer having 2 isocyanate groups or less with a polyol; at least one of a thermally conductive ceramic and a flame-retardant ceramic; a moisture scavenger for controlling reaction with moisture; and a curing retardant first reacting with a secondary amine and a hydroxyl group, thereby increasing preservation stability of a curing agent, wherein the secondary amine and the hydroxyl group are generated by a reaction of the moisture scavenger with moisture, wherein, in some cases, the curing agent composition may include a dispersing agent enhancing dispersity, a thixotropy assigning additive assigning thixotropy, and so on.

Additionally, the present invention provides a two-component thermally conductive polyurethane gap filler composition comprising a primary agent composition comprising a polyol having one hydroxyl group, a polyol having two hydroxyl groups, and a polyol having 3 to 64 hydroxyl groups at a terminal; a curing agent composition comprising a polyisocyanate having 2 isocyanates or less; at least one of a thermally conductive inorganic filler and a flame-retardant inorganic filler being included in the primary agent composition and the curing agent composition; a catalyst; and a moisture scavenger.

### Effects of the Invention

As described above, according to an example of the present invention, provided herein is a two-component thermally conductive polyurethane (PU) composition that is capable of being preserved at room temperature for 180 days or more, and the two-component thermally conductive polyurethane (PU) composition is expected to be applied as an effective thermally conductive gap filler of a secondary cell (or rechargeable battery) module, pack, and BMS for an electric/electronic device and transportation means driven by a secondary cell.

### BRIEF DESCRIPTION OF THE DRAWINGS

FIG. 1 is a graph showing room temperature preservation stability test results of a curing agent composition comprising an oxazolidine derivative as a moisture scavenger and an acyl halide as a curing retardant (Exemplary embodiment 1) and a curing agent composition not comprising a moisture scavenger and a curing retardant (Comparative example 1).

FIG. 2 is a graph showing accelerated preservation stability test results of a curing agent composition comprising an oxazolidine derivative as a moisture scavenger and an acyl halide as a curing retardant (Exemplary embodiment 1) and a curing agent composition not comprising a moisture scavenger and a curing retardant (Comparative example 1).

### MODE FOR CARRYING OUT THE INVENTION

Hereinafter, the present invention will be described in more detail based on a preferred embodiment of the present invention.

The present invention relates to a composition of a two-component thermally conductive gap fill that is capable of being preserved at room temperature, the composition being used in a secondary cell (or rechargeable battery) module, pack, and battery management system (BMS) for an electric/electronic device and transportation means driven by a secondary cell.

For example, the composition of the present invention may be a thermally conductive gap filler that is injected inside a secondary cell module case, so as to fill a gap formed between the secondary cell and the module case, and that is used to transfer heat generated from charging and discharging the cell outside of the case.

As another example, the composition of the present invention may be a thermally conductive gap filler that is used for reducing thermal resistance when manufacturing a pack that is formed of a group of modules, by filling a gap between a heat sink, which is a heat dissipating device, and so on, and the pack.

In the previously applied Korean Patent Application No. 10-2020-0150572 and No. 10-2021-0178537, the inventors of the present invention disclosed the excellent moisture removing (or scavenging) effect by first reacting oxazolidine derivatives, such as Chemical formula 1, which is used as a moisture scavenger, with moisture.

By having the oxazolidine derivatives first react with moisture, the moisture may be effectively removed (or scavenged), thereby preventing reaction between an isocyanate group, which is a component of the curing agent, and moisture. However, in this case, a multi-functional by-product having a secondary amine and a hydroxyl group in a molecule, at the same time, as shown in Chemical formula 2, may be generated. And, by having the by-product react with an isocyanate, so as to increase viscosity of the curing agent, ultimately, preservation stability of the curing agent may not be enhanced.

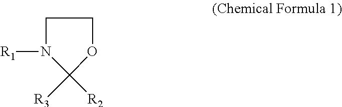

Herein,
R₁ is a linear hydrocarbon with 1˜4 carbons or a branched hydrocarbon with 3˜8 carbons,
R₂ is a linear hydrocarbon with 1˜12 carbons or a branched hydrocarbon with 3˜18 carbons, and
R₃ is a methyl group (CH₃—) or hydrogen (H).

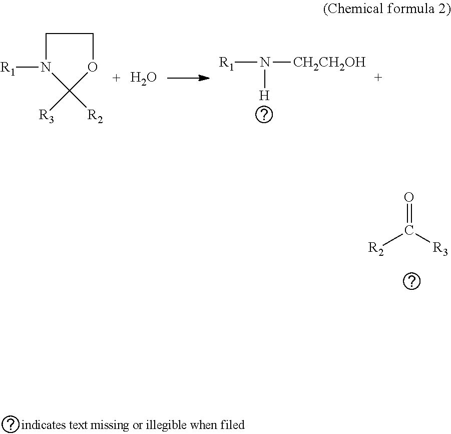

Accordingly, the inventors of the present invention completed the present invention from understanding that acyl halide derivatives, as shown below in Chemical formula 2, react with secondary amines and hydroxyl group at a higher priority than an isocyanate.

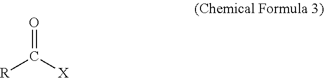

Herein,
R is selected from one of 1 to 4 described below.
1. An aliphatic hydrocarbon being replaced with one of C1˜C18 alkyls, C3˜C18 isoalkyls, C2˜C18 alkenyls, and C4˜C18 isoalkenyls.
2. An aromatic hydrocarbon being replaced with one to five of C1˜C8 alkyls, C3˜C8 isoalkyls, C2˜C8 alkenyls, and C4˜C8 isoalkenyls.
3. A bicyclic aromatic hydrocarbon (BAH) being replaced with one to seven of C1˜C8 alkyls, C3˜C8 isoalkyls, C2˜C8 alkenyls, and C4˜C8 isoalkenyls.
4. A polycyclic aromatic hydrocarbon (PAH) being replaced with one to four of C1˜C8 alkyls, C3˜C8 isoalkyls, C2˜C8 alkenyls, and C4˜C8 isoalkenyls, and having three to five rings.
X is selected from a halogen atom.

Additionally, in the present invention, it is preferable that the composition is a two-component polyurethane composition including a primary agent composition including polyols, and so on, and a curing agent composition including polyisocyanate, and so on.

In order to ensure thermal conductivity, the composition should include thermally conductive ceramics having excellent thermal conductivity. And, in order to assign fire retardancy to the secondary cell module, pack, and so on, it is preferable to use ceramics having both thermal conductivity and fire retardancy at the same time, such as aluminum trihydrate.

Additionally, since the composition is applied to the manufacturing of secondary cell modules and packs, and so on, which are sensitive to heat, the composition must be cured at room temperature, and, in order to control a curing rate (or speed), a tin-based catalyst, such as dibutyltin dilaurate, and so on, or an amine-based catalyst, such as 1,4-diazabicyclooctane, may be added. However, the present invention will not be limited to this.

Moreover, a dispersing agent that can enhance dispersity of ceramic, and, when needed, an additive that can assign thixotropy may be mixed and used in the primary agent composition.

Furthermore, a dispersing agent that can enhance dispersity of ceramic, an additive that can assign thixotropy, when needed, a moisture scavenger that can prevent bubbles from forming in the thermally conductive gap filler, wherein the bubbles are generated from the composition due to moisture, and a curing retardant may be mixed and used in the curing agent composition.

As an example of the present invention, it is preferable to use a mixture of a polyol having 2 hydroxyl groups and a polyol having 3 to 64 hydroxyl groups as the polyol configuring the primary agent composition. It is also preferable that an added amount of the polyol having 3 to 64 (3˜64) hydroxyl groups is within a range of 0.1% by weight to 10% by weight for each polyol having 2 hydroxyl groups.

Herein, in case the added amount of the polyol having 3 to 64 hydroxyl groups is less than 0.1% by weight, when mixed with the curing agent composition, which will be described below, curing does not occur. And, when more than 10% by weight is added, excessive curing occurs, thereby causing a loss in the shock absorbing function of the electric/electronic device, secondary cell module, pack, and so on.

Additionally, a polyol having one hydroxyl group may be used for controlling the hardness of the two-component polyurethane, which is generated by adding a primary agent and a curing agent. Herein, it is preferable that the added amount is within a range of 0% by weight to 50% by weight for each polyol having 2 hydroxyl groups.

Herein, when 50% by weight of the polyol having one hydroxyl group is used, the hardness becomes low, thereby causing a loss in its fixing function of the electric/electronic device, secondary cell module, pack, and so on.

Although the type of polyol that is used for the primary agent composition is not limited, it is preferable to select the polyol based on its adhesion (or adhesive force) to the case of the pack or module applied herein. And, a single polyol or a mixture of polyols, among polyols having an ester bond, a urethane bond, a carbonate bond, or an ether bond, may be used in a polyol main chain.

Additionally, as described below, since a polyol used in the primary agent composition should contain a large amount of thermally conductive ceramics, it is preferable that the polyol is in a liquid form at room temperature and has a viscosity of 2,000 cps or less.

As an example of the present invention, although the type of isocyanate that is used for the curing agent composition is not limited, in order to ensure preservation stability of the curing agent, it is preferable to mandatorily use a bivalent isocyanate or less.

Since a Buret reaction has a slower reaction speed (or rate) as compared to a urea reaction, this does not influence the preservation stability.

As an example of the present invention, it is preferable that a mixture ratio of the primary agent composition and the curing agent composition is within an isocyanate ratio range of 0.8˜1.2 for each hydroxyl group based on a mol ratio.

If a weight ratio of an isocyanate for each hydroxyl group is low, this may decrease the hardness of the thermally conductive gap filler, which is manufactured by being mixed. And, if a weight ratio of an isocyanate for each hydroxyl group is high, this may not only increase the hardness of the thermally conductive gap filler but may also increase the curing speed (or rate).

If a weight ratio of isocyanate for each hydroxyl group is low, the hardness of the thermally conductive gap filler, which is manufactured by mixture, may be reduced, and if a weight ratio of isocyanate for each hydroxyl group is high, the hardness of the thermally conductive gap filler may not only be increased but the curing speed (or rate) may be controlled to become faster.

As an example of the present invention, a thermally conductive ceramic should be included in order to ensure thermal conductivity. And, although the ceramic type is not restricted, one type or a mixture of two types or more selected from a ceramic group having excellent thermal conductivity, such as alumina (Al₂O₃), silicon carbide (SIC), silicon nitride (Si₃N₄), boron nitride (BN), zinc oxide (ZnO), and so on, may be used.

Moreover, in addition to the thermal conductivity, in order to assign flame-retardancy, one or a mixture of aluminum trihydroxide (hereinafter referred to as “ATH”), magnesium dihydroxide (or magnesium hydroxide) (Mg(OH)₂), calcium carbonate (CaCO₃), and so on, may be used.

Additionally, the thermally conductive ceramic and the ceramic assigning flame-retardancy may be mixed and used. And, based on the composition 100% by weight, if the composition contains less than 25% by weight of the flame-retardant ceramic, the composition will not be flame-retardant. Therefore, in order to assign flame-retardancy, it is preferable that the composition contains 25% by weight or more of the flame-retardant ceramic based on the 100% by weight of the composition.

Additionally, as an example of the present invention, when the amount of polyols and isocyanates used in the primary agent and the curing agent is given as 100% by weight, it is preferable that a charging ratio of the thermally conductive and flame-retardant ceramics, which are included in the thermally conductive gap filler, contains 250˜1,350% by weight.

When the composition contains less than 250% by weight, the composition has low thermal conductivity that it cannot be applied as a thermally conductive gap filler. And, when the composition contains more than 1,350% by weight, the dispersion cannot be carried out effectively. Thus, when applied to the electric/electronic device and module, and so on, the composition cannot effectively perform its fixing function.

Although, in some case, silane is used as an absorbent for enhancing the preservation stability of the curing agent composition, this can be realized only when the moisture existing in the composition reacts first with an alkoxy (—OR) group of the silane rather than the isocyanate.

Therefore, in order to achieve the object of the present invention, as an example of the present invention, in order to prevent amine from being formed in the thermally conductive gap filler, wherein the amine is formed by the moisture, it is more preferable to add a moisture scavenger, such as oxazolidine derivatives, shown in Chemical formula 1 as follows.

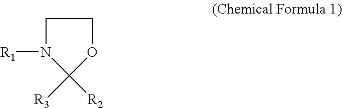

Herein,
R₁ is a linear hydrocarbon with 1˜4 carbons or a branched hydrocarbon with 3˜8 carbons,
R₂ is a linear hydrocarbon with 1˜12 carbons or a branched hydrocarbon with 3˜18 carbons, and
R₃ is a methyl group (CH₃—) or hydrogen (H).

As an example of the present invention, bubbles may be prevented from being formed in a thermally conductive gap filler by using a moisture scavenger. However, since the viscosity of the curing agent continues to increase due to a reaction of the secondary amine and hydroxyl group, which are generated by the reaction between the moisture scavenger and moisture, with the isocyanate that is included in the curing agent composition, the preservation stability is not significantly enhanced.

Accordingly, by adding a curing retardant, such as acyl halide, so that the secondary amine and hydroxyl group, which are generated by the reaction between the moisture scavenger and moisture, can first react with the curing retardant, the preservation stability may be enhanced.

It is preferable that the curing retardant uses acyl halide derivatives having a same structure as Chemical formula 2 shown below.

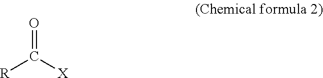

Herein,
R is selected from one of 1 to 4 described below, and X is selected from a halogen atom. Herein, R is as described below.
1. An aliphatic hydrocarbon being replaced with one of C1˜C18 alkyls, C3˜C18 isoalkyls, C2˜C18 alkenyls, and C4˜C18 isoalkenyls.
2. An aromatic hydrocarbon being replaced with one to five of C1˜C8 alkyls, C3˜C8 isoalkyls, C2˜C8 alkenyls, and C4˜C8 isoalkenyls.
3. A bicyclic aromatic hydrocarbon (BAH) being replaced with one to seven of C1˜C8 alkyls, C3˜C8 isoalkyls, C2˜C8 alkenyls, and C4˜C8 isoalkenyls.
4. A polycyclic aromatic hydrocarbon (PAH) being replaced with one to four of C1˜C8 alkyls, C3˜C8 isoalkyls, C2˜C8 alkenyls, and C4˜C8 isoalkenyls, and having three to five rings.

According to another embodiment, the present invention may provide a two-component thermally conductive polyurethane gap filler composition comprising a primary agent composition comprising a polyol having one hydroxyl group, a polyol having two hydroxyl groups, and a polyol having 3 to 64 hydroxyl groups at a terminal; a curing agent composition comprising a polyisocyanate having 2 isocyanates or less; at least one of a thermally conductive inorganic filler and a flame-retardant inorganic filler being included in the primary agent composition and the curing agent composition; a catalyst; and a moisture scavenger.

Evaluation results according to an embodiment of the present invention will hereinafter be presented as follows.

### EVALUATION METHOD

### 1. Room Temperature Preservation Stability Evaluation

The storage (or preservation) stability was tested (or evaluated) by preserving (or storing) the manufactured curing agent at room temperature for a period of 6 months, measuring the curing agent at a 10-day interval, and comparing the measurements for evaluation. And, if the viscosity is measured to be two times the initial viscosity or higher, the curing agent is assessed (or evaluated) to have no preservation stability.

### 2. Accelerated Preservation Stability Evaluation

The accelerated storage (or preservation) stability was tested (or evaluated) by preserving (or storing) the manufactured curing agent in an oven at 40 degrees Celsius (40° C.) for a period of 2 months, measuring the curing agent at a 10-day interval, and comparing the measurements for evaluation. And, if the viscosity is measured to be two times the initial viscosity or higher, the curing agent is assessed (or evaluated) to have no preservation stability.

### 3. Method of Measuring the Curing Agent Viscosity

The viscosity was measured according to the ASTM D4440 standard by using the Anton-Paar (rheometer) MCR 102.

The shear rate was 2.4/s viscosity, and the plate gap was measured to be 0.5 millimeters (mm).

### <Method of Manufacturing a Sample>

### 1. Exemplary Embodiment 1

1) A polyurethane prepolymer was manufactured by adding HDI of 90% by weight to a polyester polyol having a viscosity of 400 mPa·s (Kuraray polyol P-510, Japan) of 100% by weight and reacting the mixture for 2 hours and synthesizing the mixture with a bivalent polyisocyanate.

2) A curing agent sample was manufactured by adding alumina 800% by weight, a non-ionic dispersing agent, (normal block Mn: 1,200 Daltons) 1% by weight, N-butyl-2-(1-ethylpentyl)-1,3-oxazoladine 3.5% by weight as the moisture scavenger, and benzoyl chloride 1.5% by weight as the curing retardant to the manufactured prepolymer 100% by weight, and by dispersing the mixture in a high-viscosity disperser for 4 hours.

### 2. Comparative Example 1

A curing agent sample was manufactured by adding substances just as in the Exemplary embodiment 1 excluding benzoyl chloride, an oxazolidine derivative, and by dispersing the mixture in a high-viscosity disperser for 4 hours.

### <Measurement Results>

TABLE 1
Room temperature preservation stability (Viscosity value measurements)

| | 0 day | 10 days | 20 days | 30 days | 40 days | 50 days | 60 days | 70 days | 80 days | 90 days |
|---|---|---|---|---|---|---|---|---|---|---|
| Exemplary | 133,000 | 159,000 | 163,000 | 165,000 | 170,000 | 175,000 | 178,000 | 181,000 | 185,000 | 185,000 |
| embodiment 1 | | | | | | | | | | |
| Comparative | 145,000 | 250,000 | 400,000 | Non- | Non- | Non- | Non- | Non- | Non- | Non- |
| example 1 | | | | measurable | measurable | measurable | measurable | measurable | measurable | measurable |

| | 100 days | 110 days | 120 days | 130 days | 140 days | 150 days | 160 days | 170 days | 180 days |
|---|---|---|---|---|---|---|---|---|---|
| Exemplary | 190,000 | 193,000 | 195,000 | 196,000 | 200,000 | 203,000 | 205,000 | 207,000 | 210,000 |
| embodiment 1 | | | | | | | | | |
| Comparative | Non- | Non- | Non- | Non- | Non- | Non- | Non- | Non- | Non- |
| example 1 | measurable | measurable | measurable | measurable | measurable | measurable | measurable | measurable | measurable |

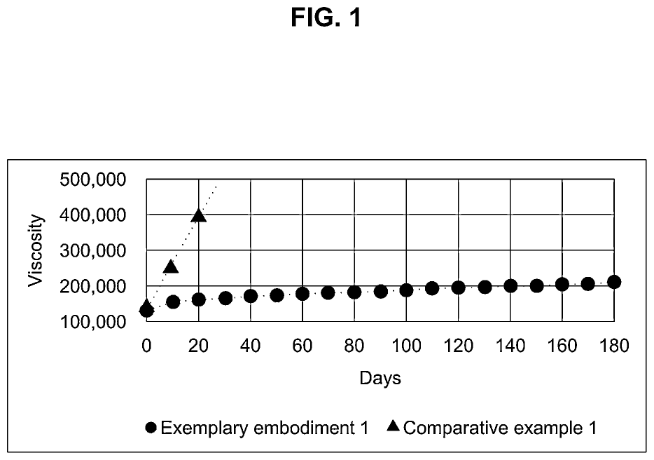

As shown in Table 1 presented above, according to the results of measuring the room temperature preservation stability, it is apparent that, in the exemplary embodiment, the viscosity increases comparatively slowly as the time passes. However, it is apparent that, in the comparative example, the viscosity increases at a high rate even before 30 days, and that, after 30 days, the viscosity maintains a state of high-viscosity up to a point where it is non-measurable, which indicates that the sample cannot be used as a curing agent. The comparison may also be verified in FIG. 1.

TABLE 2
Accelerated preservation stability (Viscosity value measurements)

| | 0 day | 10 days | 20 days | 30 days | 40 days | 50 days | 60 days |
|---|---|---|---|---|---|---|---|
| Exemplary | 133,000 | 181,000 | 190,000 | 198,000 | 205,000 | 220,000 | 250,000 |
| embodiment 1 | | | | | | | |
| Comparative | 145,000 | Non- | Non- | Non- | Non- | Non- | Non- |
| example 1 | | measurable | measurable | measurable | measurable | measurable | measurable |

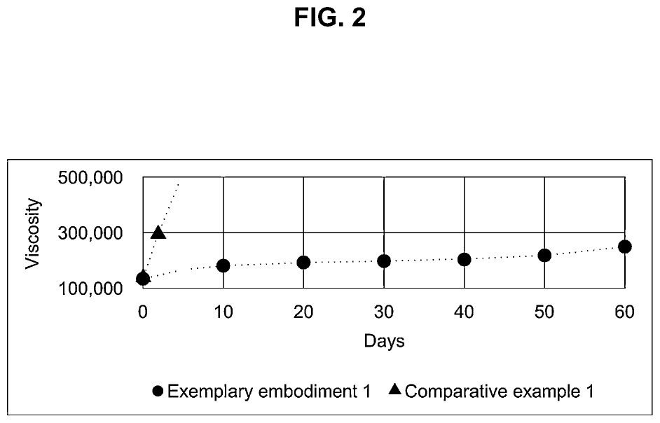

As shown in Table 2 presented above, according to the results of measuring the accelerated preservation stability, it is apparent that, in the exemplary embodiment, the viscosity increases comparatively slowly as the time passes. However, it is apparent that, in the comparative example, the viscosity is not noticeably different from the exemplary embodiment before 10 days, whereas, after 30 days, the viscosity maintains a state of high-viscosity up to a point where it is non-measurable, which indicates that the sample cannot be used as a curing agent. The comparison may also be verified in FIG. 2.

Therefore, it could be verified that the curing agent according to the present invention had excellent preservation stability, thereby being appropriate for long-term preservation.

Although a detailed description of the present invention is given based on the exemplary embodiment of the present invention, the present invention will not be limited only to the exemplary embodiment set forth herein. It will be apparent to anyone skilled in the art that various modifications and variations can be made in this specification without departing from the spirit or scope of the present invention. Thus, it is intended that the exemplary embodiment disclosed in the present invention merely provides a detailed description of the technical scope and spirit of the present invention without limitation and shall not limit the technical scope and spirit of the present invention. It should be understood that this specification covers the modifications and variations of this invention provided they come within the scope of the appended claims and their equivalents.

What is claimed is:

1. A two-component thermally conductive polyurethane gap filler composition, comprising:
a primary agent composition comprising a mixture of two or more polyol types selected from a polyol having one hydroxyl group, a polyol having two hydroxyl groups, and a polyol having 3 to 64 hydroxyl groups, and a catalyst; and
a curing agent composition comprising at least one selected from a monomer having 2 isocyanate groups or less at a terminal, a polyurethane precursor generated by reacting a monomer having 2 isocyanate groups or less at a terminal with a polyol, a moisture scavenger, and a curing retardant.

2. The two-component thermally conductive polyurethane gap filler composition of claim 1, wherein the primary agent composition or curing agent composition further comprises at least one of a thermally conductive ceramic and a flame-retardant ceramic.

3. The two-component thermally conductive polyurethane gap filler composition of claim 1, wherein the primary agent composition or curing agent composition further comprises a dispersing agent and a thixotropy assigning additive.

4. The two-component thermally conductive polyurethane gap filler composition of claim 1, wherein the moisture scavenger contains at least one or more of oxazolidine derivatives each having a structure including Chemical formula 1 as shown below: 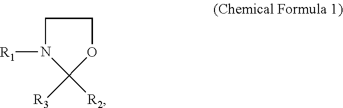
wherein
R₁ is a linear hydrocarbon with 1˜4 carbons or a branched hydrocarbon with 3˜8 carbons,
R₂ is a linear hydrocarbon with 1˜12 carbons or a branched hydrocarbon with 3˜18 carbons, and
R₃ is a methyl group (CH₃—) or hydrogen (H).

5. The two-component thermally conductive polyurethane gap filler composition of claim 1, wherein the curing retardant contains at least one or more of acyl halide derivatives each having a structure including Chemical formula 2 as shown below: 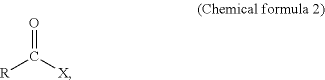
wherein R is:
1. an aliphatic hydrocarbon, or an aliphatic hydrocarbon being replaced with at least one type selected from an Alkyl (Cn=1˜18), an Isoalkyl (Cn=3˜18), an Alkenyl (Cn=2˜18), and an Isoalkenyl (Cn=4˜18),
2. an aromatic hydrocarbon, or an aromatic hydrocarbon being replaced with one to five types selected from an Alkyl (Cn=1˜8), an Isoalkyl (Cn=3˜8), an Alkenyl (Cn=2˜8), and an Isoalkenyl (Cn=4˜8),
3. a bicyclic aromatic hydrocarbon (BAH), or a bicyclic aromatic hydrocarbon being replaced with one to seven types selected from an Alkyl (Cn=1˜8), an Isoalkyl (Cn=3˜8), an Alkenyl (Cn=2˜8), and an Isoalkenyl (Cn=4˜8), and
4. a polycyclic aromatic hydrocarbon (PAH) having three to five rings, or a polycyclic aromatic hydrocarbon being replaced with one to four types selected from an Alkyl (Cn=1˜8), an Isoalkyl (Cn=3˜8), an Alkenyl (Cn=2˜8), and an Isoalkenyl (Cn=4˜8).

6. The two-component thermally conductive polyurethane gap filler composition of claim 1, wherein, when a weight of the composition is given as 100%, the composition comprises 0 to 50% by weight of the polyol having one hydroxyl group, 50 to 99.9% by weight of the polyol having two hydroxyl groups, and 0.1 to 10% by weight of the polyol having 3 to 64 hydroxyl groups.

7. The two-component thermally conductive polyurethane gap filler composition of claim 1, wherein, among the compositions, the monomer having 2 isocyanates or less at a terminal and the prepolymer both configuring the curing agent, are used within a range of 80% to 120% for each hydroxyl value of the primary agent.

8. A two-component thermally conductive polyurethane gap filler composition, comprising:
a primary agent composition comprising a polyol having one hydroxyl group, a polyol having two hydroxyl groups, and a polyol having 3 to 64 hydroxyl groups at a terminal;
a curing agent composition comprising a polyisocyanate having 2 isocyanates or less;
at least one of a thermally conductive inorganic filler and a flame-retardant inorganic filler being included in the primary agent composition and the curing agent composition;
a catalyst; and
a moisture scavenger.
